(19) United States
(12) Patent Application Publication
(10) Pub. No.: US 2019/0225381 A1
(43) Pub. Date: Jul. 25, 2019

(54) TREATMENT OF CLOSURE ENDS ON LARGE FORMAT BAGS

(71) Applicant: David ANZINI, Middletown, NY (US)

(72) Inventor: David ANZINI, Middletown, NY (US)

(21) Appl. No.: 16/336,150

(22) PCT Filed: Oct. 25, 2017
(86) PCT No.: PCT/US17/58203

§ 371 Date: Mar. 25, 2019

Related U.S. Application Data
(60) Provisional application No. 62/413,644, filed on Oct. 27, 2016.

(51) Int. Cl. B65D 30/20; B65D 33/25

(52) U.S. Cl. CPC B65D 31/10; B31B 70/148; B65D 33/2508

(57) ABSTRACT

A reclosure, closure or zipper (40) is mounted to the top of a large format package or bag (10), which may be formed from a tube of polymeric material and comprises a first wall (12), a second wall (14), a first gusset (16) and a second gusset (18), the first and second gussets (16, 18) respectively connecting first and second side edges (20, 22) of the first and second walls. The upper corners of the package or bag include notches (24, 26) in the gussets (16, 18). The areas of the package walls around the notches are pinned, glued or sealed together and the closure is attached to the package walls (12, 14). The ends (41, 43) of the reclosure, closure or zipper are flush with the side edges or seals (20, 22) of the package or bag.

This application is a National Phase application of PCT/US2017/058203, filed on Oct. 25, 2017, which claims priority under 35 U.S.C. 119(e) of U.S. provisional application Ser. No. 62/413,644, filed on Oct. 27, 2016, the contents of which are hereby incorporated by reference in their entirety and for all purposes.

### BACKGROUND OF THE DISCLOSURE

### Field of the Disclosure

The disclosure pertains to a closure on a large format bag that typically is mounted to the top of the bag with the ends of the closure flush to the sides of bag.

### Description of the Prior Art

With respect to polywoven large format bags (“large format bags” generally referring to bags intended for at least fifteen pounds of product), reclosure prior art has typically taken the form of a large flanged closure that is sealed to the external faces of the bag, with the flange portions of the closure extending beyond the sides of the bag, typically by a half-inch or more. This is functional but not aesthetically pleasing. In addition, the extra flange material can become cumbersome in the user's fill-seal operation. Embodiments of this disclosure address both of the above issues by providing a closure and means of attachment that renders the closure ends flush with the sides of the bag material.

### OBJECTS AND SUMMARY OF THE DISCLOSURE

It is therefore an object of the present disclosure to provide a closure for a large format package or bag which will run on fill and seal machinery more efficiently than in the prior art. In particular, a closure is sought wherein the ends have a reduced propensity to catch on the machinery.

It is therefore a further object of the present disclosure to provide a closure for a large format package or bag which is resistant to insect or pest infiltration and which is aesthetically pleasing to the consumer.

These and other objects are attained by providing a closure on a large format gusseted package or bag that is mounted to the top of the bag with the ends of the closure flush to the sides of the bag. The side gussets are notched near the top of the bag, and the area around the gussets is pinned, sealed or glued.

### BRIEF DESCRIPTION OF THE DRAWINGS

Further objects and advantages of the disclosure will become apparent from the following description and from the accompanying drawings, wherein:

FIG. 1 is a plan view, partially in phantom, of a gusseted package of the prior art.

FIG. 2A is a plan view, partially in phantom, of polywoven tube, a step in the manufacturing process of an embodiment of the present disclosure.

FIG. 2B is a cross-sectional view along plane 2B-2B of FIG. 2A.

FIG. 3A is a plan view, partially in phantom of the polywoven tube, illustrating a further step in the manufacturing process of an embodiment of the present disclosure, wherein the sides of the tube, including a portion of the gussets have been partially removed.

FIG. 3B is a cross-sectional view along plane 3B-3B of FIG. 3A.

FIG. 4 is a plan view, partially in phantom, illustrating the position of the reclosure or zipper with respect to the gusset material removed, in an embodiment of the present disclosure.

FIG. 5A is a plan view, partially in phantom, illustrating the top of the package of an embodiment of the present disclosure.

FIG. 5B is a cross-sectional view along plane 5B-5B of FIG. 5A.

FIG. 5C is a cross-sectional view along plane 5C-5C of FIG. 5A.

FIG. 5D is a cross-sectional view along plane 5D-5D of FIG. 5A.

### DETAILED DESCRIPTION OF THE PREFERRED EMBODIMENTS

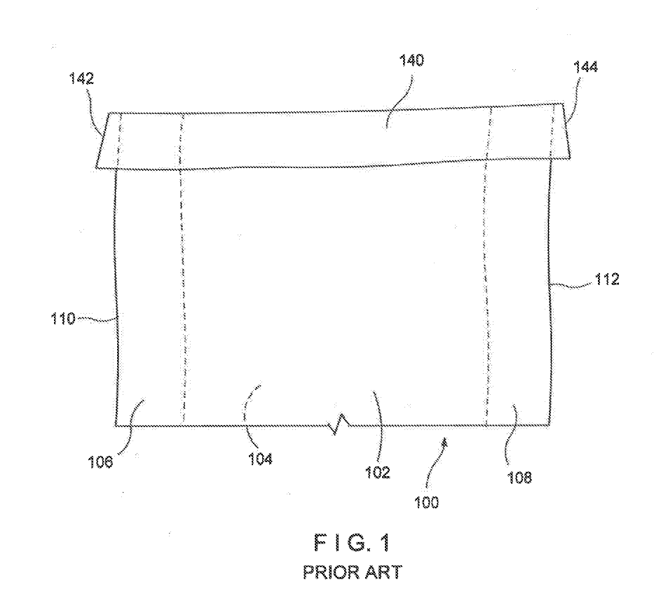

Referring now to the drawings in detail wherein like numerals refer to like elements throughout the several views, one sees that FIG. 1 is a representation of a gusseted package 100 of the prior art, including flanges of the reclosure 140 wherein the ends 142, 144 extend beyond the side edges or seals 110, 112 of the package 100 as formed by front and rear walls 102, 104 which are joined to each other by first and second side gussets 106, 108.

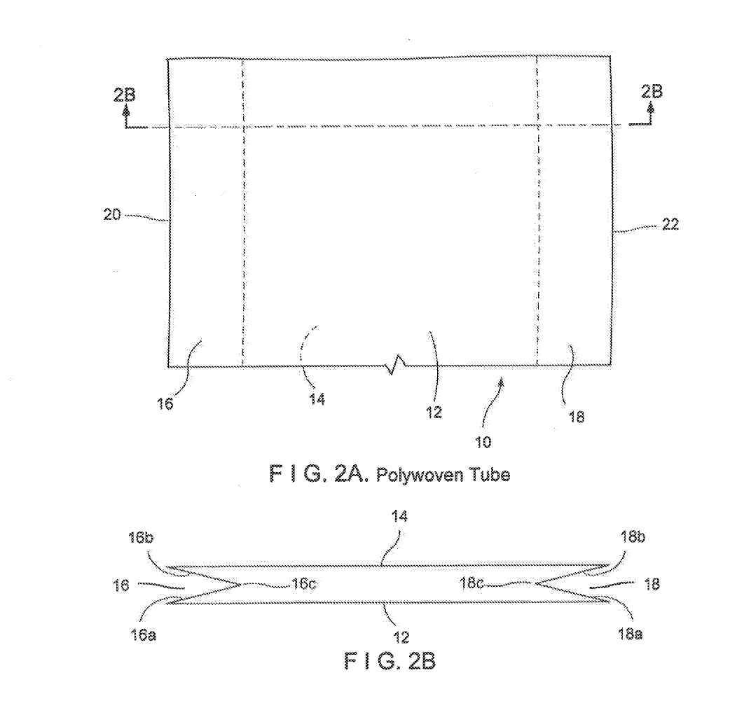

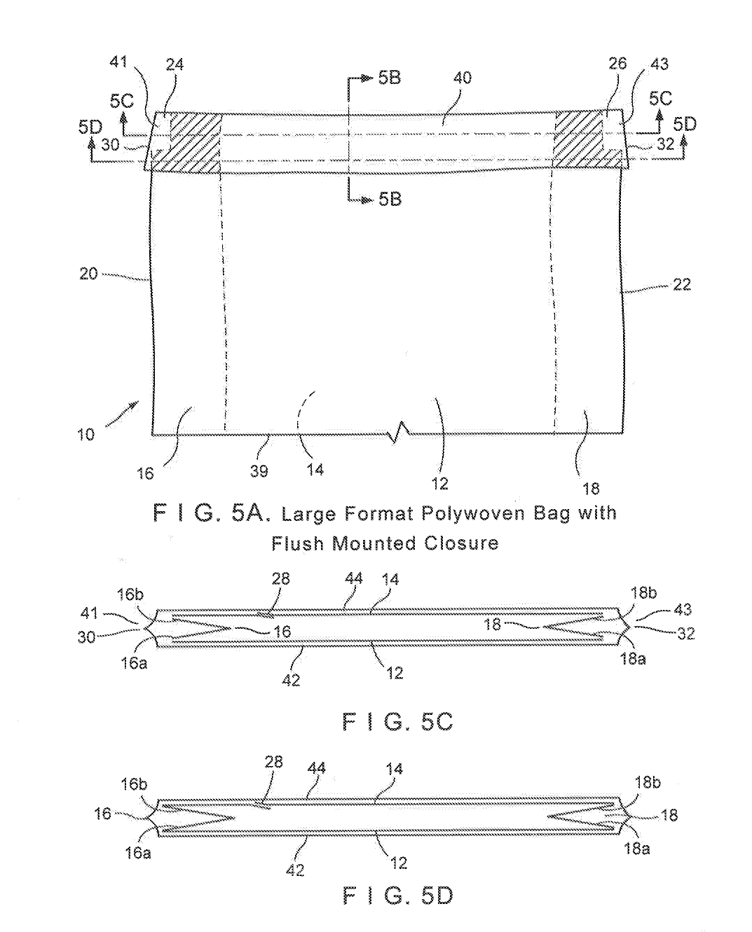

FIG. 2A illustrates an embodiment of the present disclosure, showing a typical top of a polywoven or polymeric tube which is formed from front wall 12, rear wall 14 and first and second side gussets 16, 18, as bounded by first and second side seals or edges 20, 22, respectively (the tube may be formed from a single sheet of polymeric material by way of lap seal 28 as shown in FIGS. 5C and 5B). A storage volume for consumer or other products is formed between the front and rear walls 12, 14. Moreover, as shown in the cross-sectional view of FIG. 2B, first side gusset 16 is formed by first gusset front wall 16a and first gusset rear wall 16b, which are connected or integral with each other at a first interior apex 16c, and connected or integral with front wall 12 and rear wall 14, respectively. Likewise, second side gusset 18 is formed by second gusset front wall 18a and second gusset rear wall 18b, which are connected or integral with each other at a second interior apex 18c, and connected or integral with front wall 12 and rear wall 14, respectively. This configuration is a manufacturing precursor component to the finished bag or package 10 (see FIG. 5A). The illustrated embodiment has relatively deep first and second side gussets 16, 18.

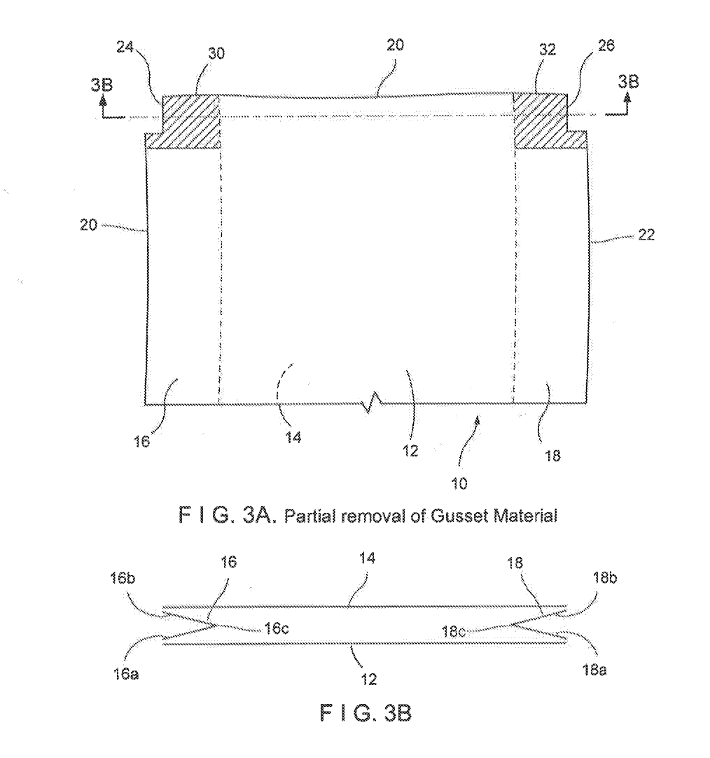

FIG. 3A illustrates a subsequent manufacturing precursor to the finished bag or package 10. FIG. 3A shows the partial removal of the sides of the tube, approximately half the depth of the first and second side gussets 16, 18, thereby resulting in first and second notches 24, 26, on opposed extremes of the upper edge of the front wall 12 and the rear wall 14 and on the upper portions of first and second side seals or edges 20, 22 respectively. This step of forming the first and second notches 24, 26 may be performed prior to or after the typical treatment of the first and second side gussets 16, 18 with hot melt adhesive, thereby pinning, sealing or gluing the first and second side gussets 16, 18 together at the top of the bag or package 10 in first and second gusset seal areas 33, 35 as shown in hatching in FIGS. 3A and 5A. FIG. 3B illustrates that the first and second interior apices 16c, 18c remain intact immediately inwardly adjacent from the respective first and second notches 24, 26, while the connection between first and second gusset front walls 16a, 18a and front wall 12 and between first and second gusset rear walls 16b, 18b and rear wall 14 have been removed or severed in this area.

The first and second gusset seal areas 33, 35, as shown in FIGS. 3A and 5A, formed by the pinning, sealing or gluing of the gusset walls 16a, 16b and 18a, 18b typically prevents, minimizes or reduces pest infiltration into the package or bag 10. This is particularly important in the packaging of pet foods. Moreover, fully sealing the ends of the reclosure, closure or zipper 40 (see FIG. 5A) around the first and second side gussets 16, 18 and all the way up the sides of the reclosure, closure or zipper 40 further helps to prevent pest infiltration.

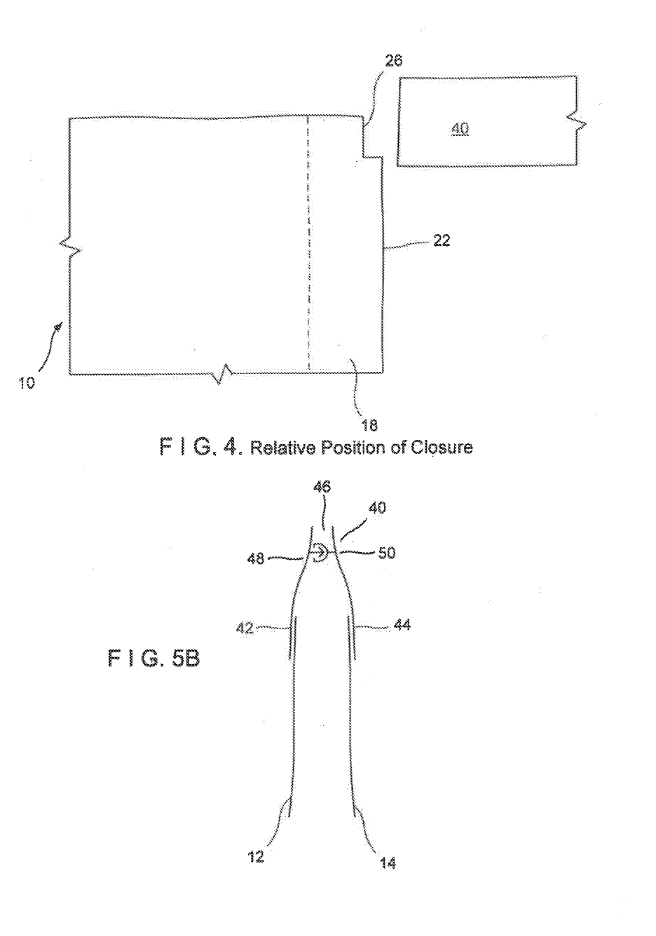

FIG. 4 shows the relative position of the reclosure, closure or zipper 40 with respect to the amount of material removed from second side gusset 18 by second notch 26. The portion of the second side gusset 18 that remains proximate to second notch 26 is pinned with hot melt adhesive or otherwise sealed or glued.

FIG. 5A shows the top of the finished package or bag 10, with a flush cut reclosure, closure or zipper 40, bounded by first and second ends 41, 43, fitted over the first and second side gussets 16, 18 and first and second notches 24, 26 of package or bag 10. The first and second ends 41, 43 of reclosure, closure or zipper 40 are substantially flush or aligned with first and second side seals or edges 20, 22, thereby typically reducing the tendency of the package or bag 10 to catch during the manufacturing, filling or similar processes. The reclosure, closure or zipper 40 is typically adhered to the polywoven front and rear walls 12, 14 by hot melt adhesive, hot air heat sealing or other similar method as would be known to a person skilled in the art. The first and second ends 41, 43 of the reclosure, closure or zipper 40 that cover the first and second notches 24, 26 (i.e., the cut-out portions of the first and second side gussets 16, 18) can be sealed with adhesive, hot air, or heat and compression with a sealing bar, or other methods as would be known to a person skilled in the art. The first and second ends 41, 43 of the reclosure, closure or zipper 40 are then flush with the first and second side seals or edges 20, 22, and the top (reclosure, closure or zipper 40) is properly sealed to the package or bag 10. Additionally, a bottom seal 39 between the bottom edges of the front wall 12 and the rear wall 14 is formed to complete the function of the package or bag 10. The disclosed package or bag 10 is particularly adaptable to a large format bag, typically holding at least fifteen pounds of product, such as, but not limited to, consumer product.

FIG. 5B illustrates a typical cross-sectional view of the reclosure, closure or zipper 40 wherein first and second flange walls 42, 44 are sealed, adhered or secured to the front and rear walls 12, 14 of the package or bag 10 as described with respect to FIG. 5A. The first flange wall 42 includes a first interlocking profile 48 (illustrated as a male element with an arrowhead) on the interior wall thereof, which interlocks with a second interlocking profile 50 (illustrated as a female with arms to receive and releasably interlock with the arrowhead shape of the male element) on the interior of second flange wall 44. The first and second interlocking profiles 48, 50 comprise the interlocking zipper element 46. In a closed configuration of the reclosure, closure or zipper 40, the first and second interlocking profiles 48, 50 are releasably interlocked with each other. In an open configuration of the reclosure, closure or zipper 40, the first and second interlocking profiles 48, 50 are at least partially released from each other The present disclosure may be practiced with a wide variety of equivalent reclosures, closures or zippers, as would be recognized by one skilled in the art.

As shown in FIGS. 5A and 5C, the first ends 41 of first and second flange walls 42, 44 can be sealed together to form first reclosure seal 30 and the second ends 43 of first and second flange walls 42, 44 can be sealed together to form second reclosure seal 32. For structural clarity, both FIGS. 5C and 5D illustrate the first and second side gussets 16, 18 somewhat spread apart, but the actual product is typically flattens this area which is pinned, glued or sealed together (such, but not limited to, a hot melt adhesive or similar material).

Thus the several aforementioned objects and advantages are most effectively attained. Although preferred embodiments of the invention have been disclosed and described in detail herein, it should be understood that this invention is in no sense limited thereby.

What is claimed is:

1. A package or bag, comprising:
a first wall and a second wall;
a first gusset connecting first edges of the first wall and the second wall;
a second gusset connecting second side edges of the first wall and the second wall;
a first notch in the first gusset, including a portion of the first wall and the second wall;
a second notch in the second gusset, including a portion of the first wall and the second wall; and
a reclosure, closure or zipper extending across the upper edge of the first wall and the second wall.

2. The package or bag of claim 1 wherein the first notch includes portions of the first edge of the first wall and the second wall and the second notch includes portions of the second edge of the first wall and the second wall.

3. The package or bag of claim 2 wherein the first notch and the second notch are on opposed extremes of an upper edge of the first and second walls.

4. The package or bag of claim 3 wherein portions of the first gusset, the first wall and the second wall are pinned, glued or sealed together proximate to the first notch.

5. The package or bag of claim 4 wherein portions of the second gusset, the first wall and the second wall are pinned, glued or sealed together proximate to the second notch.

6. The package or bag of claim 5 wherein ends of the reclosure, closure or zipper are flush with edges of the package or bag.

7. The package or bag of claim 6 wherein the first wall, the second wall, the first gusset and the second gusset are formed from a tube of polymeric or polywoven material.

8. The package or bag of claim 7 wherein the tube is formed from a single sheet of polymeric or polywoven material, wherein edges of the sheet are joined by a seal.

9. The package or bag of claim 8 wherein the seal is a lap seal.

10. The package or bag of claim 5 wherein the reclosure, closure or zipper includes a first flange wall with a first interlocking element and a second flange wall with a second interlocking element wherein, in a closed configuration, the first interlocking element is releasably interlocked with the second interlocking element.

11. The package or bag of claim 10 wherein the first interlocking element is a male element and the second interlocking element is a complementary female element.

12. A method of manufacture of a package or bag, comprising the steps of:
providing at least one sheet of polymeric material;
forming the at least one sheet of polymeric material into a tubular shape;
forming at least one gusset in the polymeric material of tubular shape;
forming an upper edge on the polymeric material of tubular shape;
forming at least one notch in the polymeric material to remove a portion of the at least one gusset;
sealing or adhering the at least one gusset around at least a portion of the at least one notch;
sealing or adhering a reclosure, closure or zipper to the upper edge of the polymeric material of tubular shape.

13. The method of manufacture of claim 12 wherein the step of providing at least one sheet of polymeric material comprises a step of providing a single sheet of polymeric material.

14. The method of manufacture of claim 13 wherein the step of forming the at least one sheet of polymeric material into a tubular shape comprises a step of forming the single sheet of polymeric material so as to provide a first wall and a second wall of the package of bag.

15. The method of manufacture of claim 14 wherein the step of forming at least one gusset comprises a step of forming a first gusset and a second gusset.

16. The method of manufacture of claim 15 wherein the step of forming at least one notch comprises a step of forming a first notch by removing a portion of the first gusset and a portion of the first and second walls and forming a second notch by removing a portion of the second gusset and a portion of the first and second walls.

17. The method of claim 16 wherein the step of sealing or adhering the at least one gusset around at least a portion of the at least one notch comprises the step of sealing or adhering the first gusset around at least a portion of the first notch and sealing or adhering the second gusset around at least a portion of the second notch.

18. The method of claim 17 wherein the step of forming the first notch and the step of forming the second notch form the first notch and the second notch at respective opposed first and second ends of the upper edge.

19. The method of claim 18 wherein the step of sealing or adhering a reclosure, closure or zipper to the upper edge of the polymeric material of tubular shape does not extend the reclosure, closure or zipper beyond side edges of the package or bag.

20. The method of claim 19 wherein the step of providing a single sheet of polymeric material comprises a step of providing a single sheet of polywoven material.
